(19) United States
(12) Patent Application Publication
(10) Pub. No.: US 2022/0120054 A1
(43) Pub. Date: Apr. 21, 2022

(54) Quick-Change System for Changing Attachments on a Construction Machine

(71) Applicant: OilQuick Deutschland KG, Steindorf (DE)

(72) Inventor: Stefan SCHAUER, Kissing (DE)

(73) Assignee: OilQuick Deutschland KG, Steindorf (DE)

(21) Appl. No.: 17/502,284

(22) Filed: Oct. 15, 2021

(30) Foreign Application Priority Data
Oct. 16, 2020 (DE) 10 2020 127 313.4

(51) Int. Cl. E02F 3/36; E02F 3/42

(52) U.S. Cl. CPC E02F 3/3663; E02F 3/3622; E02F 3/42

(57) ABSTRACT

A quick-change system for changing attachments on a construction machine with a quick coupler arranged to be pivotable about a pivot axis orthogonal to the axis of rotation by means of a hydraulic slewing drive and rotatable about an axis of rotation on a connection part by means of a hydraulic rotary drive contains mounts and at least one locking element which can be actuated by means of a hydraulic drive to hold an attachment coupled to the quick coupler. The quick-change system includes a hydraulic control device, which contains a first control circuit to drive rotary drive and slewing drive, at least one additional control circuit to supply the attachment coupled to the quick coupler and a shuttle valve arrangement to expose the hydraulic drive to the higher pressures acting in the first or the at least one additional control circuit to activate the at least one locking element.

### FIELD OF THE DISCLOSURE

The disclosure relates to a quick-change system for changing attachments on a construction machine.

### BACKGROUND

This type of quick-change system for simple and convenient changing of different attachments on construction machines is known from DE 10 2013 206 574 A1. It has a quick coupler, which is mounted to rotate in a drive housing and is rotatable by a rotary drive relative to the drive housing, and a rotary joint arranged in the drive housing with a stator and a rotor rotatable within the stator to supply a working fluid to the quick coupler. The attachments connected to the quick coupler, like tilting buckets, double-scoop buckets, shears, compactors, magnets, hydraulic hammers or the like, can be connected by the rotary drive not only about a pivot axis arranged transverse to the longitudinal axis of an excavator arm, but also about an axis of rotation orthogonal to the pivot axis.

### SUMMARY OF THE DISCLOSURE

One aspect of the disclosure relates to a quick-change system of the type just mentioned that permits locking of the attachments on the quick coupler with increased reliability.

Expedient embodiments and advantageous refinements are also disclosed.

In an embodiment, the quick-change system for changing attachments on a construction machine includes a quick coupler, which is rotatable about an axis of rotation by means of a hydraulic rotary drive and pivotable about a pivot axis orthogonal to the axis of rotation by means of a hydraulic slewing drive, and contains mounts with at least one locking element that can be actuated by means of a hydraulic drive to secure an attachment coupled to the quick coupler. The quick-change system also includes a hydraulic control device, which contains a first control circuit to control the rotary drive and the slewing drive, at least an additional control circuit to supply the attachment coupled to the quick coupler, and a shuttle valve arrangement to expose the hydraulic drive to the higher pressure acting in the first or at least one additional control circuit to actuate the locking device. The hydraulic drive for actuation of locking is then supplied from the first and the at least one additional control circuit, in which case the control circuit with the higher pressure always has priority. It can thus be ensured that locking always occurs with the highest available pressure and a higher safety standard is therefore achieved.

The shuttle valve arrangement in an expedient embodiment has two shuttle valves between the additional control circuit and the hydraulic drive. The two shuttle valves are preferably connected one behind the other and arranged so that the hydraulic drive provided for activation of locking is always exposed to the highest available pressure.

The shuttle valve arrangement is preferably a control circuit to control the movement of at least one locking element actuated by the hydraulic drive between a locking position and a release position. The control circuit can expediently contain check valves and a directional valve arranged in the manner of a rectifier circuit. It can be ensured by the control circuit that the hydraulic drive to actuate the at least one locking element occurs properly also independently of which control line of the control circuit is exposed to pressure.

In another expedient embodiment, the first and the at least one additional control circuit can be connected to the hydraulic drive via the control circuit and a rotary joint integrated in the quick coupler. Due to its design and arrangement integrated in the quick coupler, the rotary joint can have several supply channels to supply working fluid to the quick coupler. Attachments with several connections can also thereby be supplied. By connecting or combining several supply channels, high-volume supply lines can also be created to achieve higher flow rates at low back pressures.

Through the first control circuit, the rotary drive can be driven via a first directional valve, and the slewing drive via a second directional valve. Through the first control circuit, additional loads can also be driven via corresponding directional valves.

### BRIEF DESCRIPTION OF THE DRAWINGS

Further details and advantages are apparent from the following description of a preferred embodiment example with reference to the drawings. In the drawings:

FIG. 1 shows a quick-change system with a quick coupler, a connection part, and a rotary device in a perspective view;

FIG. 2 shows the quick-change system of FIG. 1 in a partial section and

FIG. 3 shows a hydraulic circuit to drive the quick-change system depicted in FIGS. 1 and 2.

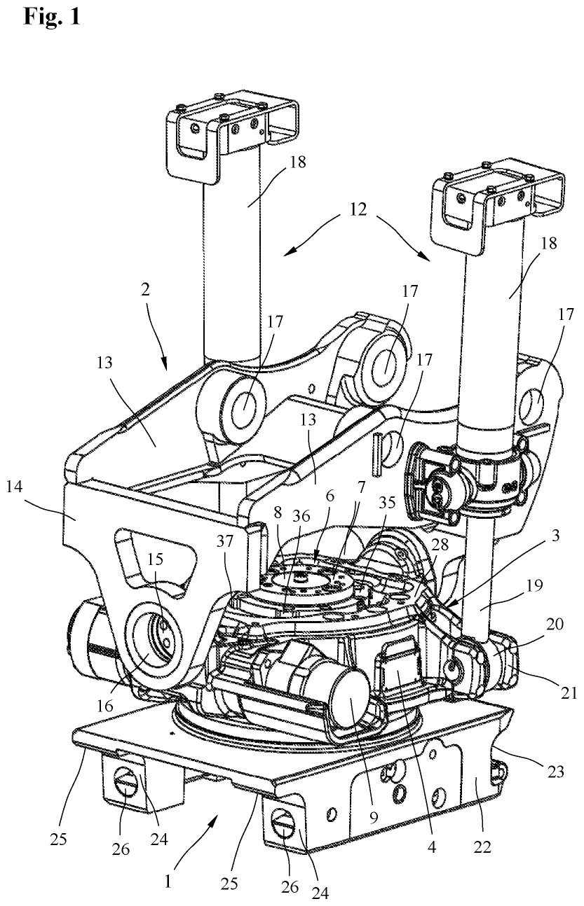

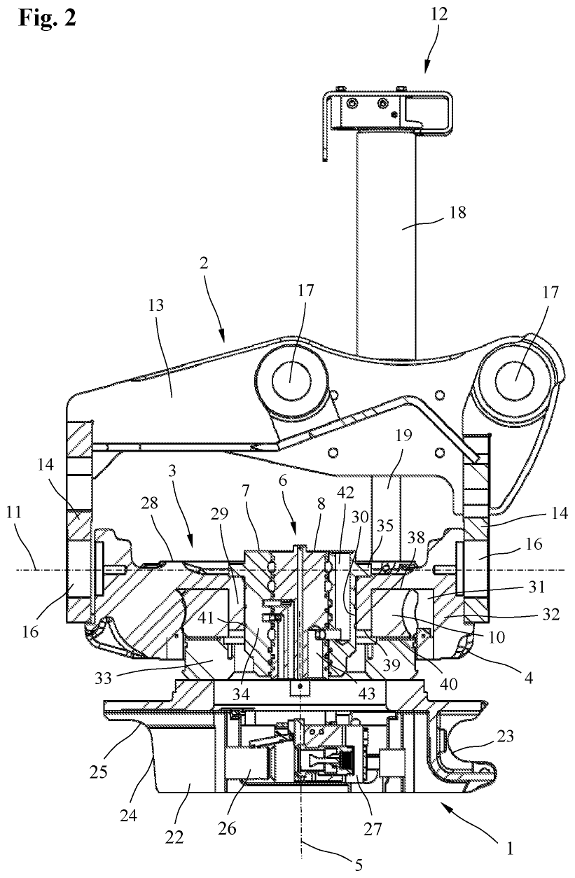

FIGS. 1 and 2 show an embodiment example of a quick-change system with a quick coupler 1 for automatic coupling of an attachment, a connection part 2 to mount the quick coupler 1 on an excavator arm or another attachment of a construction machine, and a rotary device 3 arranged between the quick coupler 1 and the connection part 2 to rotate the quick coupler 1 relative to connection part 2. The rotary device 3 contains a drive housing 4, in which a quick coupler 1 is mounted to rotate about an axis of rotation 5 shown in FIG. 2 (aligned vertically here). A rotary joint 6 is also arranged in the rotary device 3 in drive housing 4 with a stator 7 arranged in drive housing 4 rotationally fixed relative to it and a rotor 8 mounted to rotate within the stator to supply a working fluid to quick coupler 1. The quick coupler 1 is rotatable in motorized fashion by 360° around the axis of rotation 5 by a rotary drive 9 designed as a hydraulic motor depicted in FIG. 1 and a gear mechanism with a drive wheel 10 designed as a worm gear, as shown in FIG. 2 via a drive worm (not shown).

The drive housing 4 of the rotary device 3 in the depicted embodiment is arranged to pivot on the connection part 2 about a pivot axis 11 orthogonal to axis of rotation 5 and can be pivoted about pivot axis 11 relative to connection part 2 via a slewing drive 12 formed here by two operating cylinders. However, the slewing drive 12 can also be designed as a pivot motor or the like to tilt the drive housing 4 relative to connection part 2. Through such a quick change system (also referred to as a tilt rotator), the attachments connected to the quick coupler 1 can be rotated not only about axis of rotation 5, but also tilted about the pivot axis orthogonal to axis of rotation 5 relative to connection part 2, so that the movement capabilities are expanded and the area of application is thereby enlarged. The drive housing 4, however, can also be arranged without additional pivot capability fixed on connection part 2, so that the quick coupler 1 is only rotatable about axis of rotation 5 relative to connection part 2.

The connection part 2 in the depicted embodiment example has two side walls 13 parallel to each other, as well as front and rear crosspieces 14. The drive housing 4 is mounted to rotate via bearing pins 15 apparent in FIG. 1 in corresponding bearing holes 16 of the front and rear crosspieces 14 about pivot axis 11. The connection part 2 can be mounted via holes 17 in the two side walls 13 to an arm and coupling of an excavator. The slewing drive 12 in the depicted embodiment is formed by two operating cylinders with a cylinder housing 18 fastened on the corresponding side wall 13 of the connection part 2 and a piston rod 19 hydraulically movable in the cylinder housing 18, whose free end is connected via a rod end bearing 20 and a corresponding holder 21 to the drive housing 4. The drive housing 14 can be tilted relative to connection part 2 by corresponding retraction and extension of the two piston rods 19.

The quick coupler 1 depicted in a cross section in FIG. 2 contains a support 22 designed as a welded structure or cast part, which on one side has first mounts 23 open to one side to accommodate and hold a first pin-like coupling element on one side and on the other side has second mounts 24 downwardly open to the other side to accommodate and hold a second pin-like coupling element on the other side.

The quick coupler 1 in the depicted embodiment example has two mounts 23 spaced apart from each other on one side of support 22 for a front coupling element and two mounts 24 on the other side for a rear coupling element. The first mounts 23 open to one side are designed claw-like or fork-like. The second mounts 24 open downward to the other side have a curved lower support surface 25 to support a pin-like coupling element. A locking device is provided on the second mounts 24 with two pin-like locking elements 26 movable between an extended locking position and a retracted unlocking position. The two pin-like locking elements 26 are guided to move within support 22 and are movable by a hydraulic drive 27, designed here as a hydraulic cylinder (as shown in FIG. 2), between a retracted unlocking position to release or connect an adapter or an attachment and an extended locking position depicted in FIG. 1. The downwardly open second mounts 24 in the extended locking position are closed on the bottom by the locking elements 26 arranged movable in guide holes in support 22, so that the coupling element is engaged on the bottom by the pin-like locking elements 26.

In order to connect an attachment by means of the quick coupler 1, the quick coupler 1 generally arranged on an excavator arm and a coupler of an excavator via the connection part 2 is initially moved so that a front pin-like coupling element arranged on an adapter or directly on the attachment is retracted into the claw-like or fork-like mounts 23 on one side of the quick coupler 1. The quick coupler 1 is then pivoted about the front pin-like coupling element with the still withdrawn locking elements 26 so that the rear coupling element reaches the adapter or attachment on the support surfaces 25 of the downwardly open mounts 24 on the other side of the quick coupler 1. The locking elements 26 arranged movable in guide holes in support 22 of quick coupler 1 can then be extended via the hydraulic drive 27, so that the rear pin-like coupling element is engaged from below by the two locking elements 26 on quick coupler 1 and the attachment is therefore secured on the quick coupler 1.

As follows from FIG. 2, the drive housing 4 consisting of one part has an upper annular cover surface 28, a central passage opening 30 bounded by an inner bearing ring 29 of drive housing 4, and a downwardly open annular space 31 arranged around bearing ring 29 to accommodate drive wheel 10. The annular space 31 is bounded between the outside of the inner bearing ring 29 and an inside of an outer peripheral wall 32 of drive housing 4. The drive wheel 10 is mounted to be rotatable and axially-secured on the outside of the inner bearing ring 29 of drive housing 4 extending axially over almost the entire height of drive wheel 10, but also for rotatable support of the quick coupler 1 within drive housing 4. For this purpose, the support 22 of quick coupler 1 is connected via an intermediate ring 33 firmly to the axially secured drive wheel 10 mounted to rotate on the bearing ring 29 of drive housing 4. The intermediate ring 33 can be firmly welded to support 22 and firmly connected via screws to drive wheel 10.

The stator 7 has a hollow cylindrical base element 34 and an annular upper holding flange 35 with outer shoulders 36 depicted in FIG. 1 for form-fitted engagement in corresponding recesses 37 on the upper cover surface 28 of drive housing 4. The stator 7 is secured against torsion in drive housing 4 via the shoulders 36 on the holding flange 35 and the corresponding recesses 37 on the upper cover surface 28 of the drive housing 4. The outside diameter of the hollow cylindrical base element 34 is adapted to the inside diameter of the passage opening 28 in drive housing 4 so that the stator 7 is supported radially relative to drive housing 4. Radial support of stator 7 relative to drive housing 4 occurs not only in the upper area of the base element 34, but also beneath an upper end surface 38 of the drive wheel, so that the stator 7 is radially supported over a large part of its length relative to drive housing 4.

As is apparent from FIG. 2, the bearing ring 29 extends relatively far downward within drive housing 4. In the depicted embodiment, a lower end 39 of bearing ring 29 is arranged in the area of a lower end surface 40 of drive wheel 10. Stator 7 of the rotary joint 6 completely fills up the passage opening 30 in bearing ring 29, so that a closed design is obtained. Sealing elements 41 designed here as annular seals with O-shaped or rectangular cross section are arranged between the hollow cylindrical base element 34 of stator 7 and the drive housing 4. In the depicted embodiment, the stator 7 of the rotary joint 6 is arranged radially sealed in the passage opening 30 of drive housing 4 via three sealing elements 41 spaced axially apart from each other. The rotary joint 6 in known fashion has several supply channels with first channel sections 42 arranged in the stator 7 and with second channel sections 43 in rotor 8 connected to them.

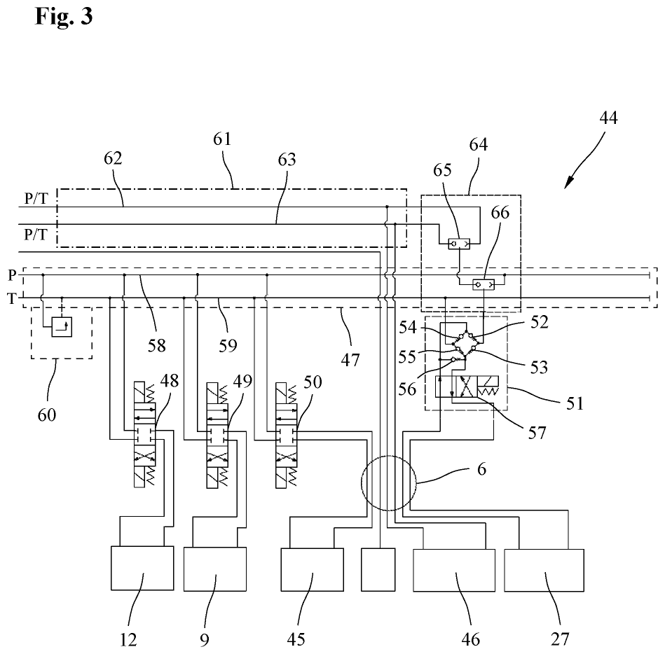

FIG. 3 shows a schematic diagram of a hydraulic control device 44 to control the quick-change system described above. The hydraulic control device 44 is designed to control the rotary drive 9 to control the rotational movement of quick coupler 1 about axis of rotation 5, to drive the slewing drive 12 to control the pivot or tilting movement of quick coupler 1 about pivot axis 11, to control the hydraulic drive 27 designed as a hydraulic cylinder for the locking device, to control an additional load 45, and to supply and drive a hydraulically operated attachment 46 coupled to the quick coupler 1. The attachment 46 can be a so-called continuous rotating element, i.e., a hammer, vibrator, or the like in continuous operation. Such attachments are ordinarily operated with a higher volumetric flow rate.

The hydraulic control device 44 contains a first control circuit 47, through which the slewing drive 12 for controlling the pivot or tilting movement of the quick coupler 1 about the pivot axis 11 via a first directional valve 48 designed as a 4/3-way valve and the rotational drive 9 to rotate the quick coupler 1 about the axis of rotation 5 via a second directional valve 49 also designed as a 4/3-way valve. An additional load 45 can also be driven by the first control circuit 47 via a third directional valve 50 designed as a 4/3-way valve. Through the first control circuit 47, the hydraulic drive 27 designed as a hydraulic cylinder can also be controlled for the locking device via a control circuit 51 with four check valves 52 to 55 arranged in the manner of a rectifier circuit, an additional check valve 56 and a spring-loaded, electrically-operated 4/2-way valve 57. The first control circuit 47 has a first control line 58 and a second control line 59 and is connected via the control circuit 51 and the rotary joint 6 to the hydraulic drive 27 for movement of the pin-like locking elements 26 shown in FIG. 2 between an extended locking position and a retracted release position. The locking elements 26 depicted in FIG. 2 in the position of the 4/2-way valve 57 shown in FIG. 3 are forced by the hydraulic drive 27 into the extended locking position. By operating the 4/2-way valve 57, on the other hand, the locking elements 26 can be moved into the retracted release position. The pressure in the first control circuit 47 can be limited to a predefined maximum value via a pressure limitation valve 60 arranged in the first control circuit 47. For example, the pressure in the first control circuit 47 can be limited to a maximum pressure of 225 bar by the pressure limitation valve 60.

To control and supply the attachment 46 connected to the quick coupler 1, the hydraulic control device 44 also contains an additional control circuit 61. The additional control circuit 61 provided with a third control line 62 and a fourth control line 63 is connected to the attachment 46 via the rotary joint 6 and is operated with a higher pressure of, e.g., 350 bar maximum relative to the first control circuit 47 in order to guarantee supply of the attachment 46 with a high volumetric flow rate.

The hydraulic control device 44 also has a shuttle valve arrangement 64 connected in front of the control circuit 51 with two shuttle valves 65 and 66 connected one behind the other. The shuttle valve arrangement 64 guarantees that the hydraulic drive 27 for activation of the locking elements 26 is acted upon with the higher pressures acting in the first or second control circuit. The hydraulic drive 27 for actuation of locking is then supplied by both control circuits 47 and 61, the control circuit with the higher pressure always having priority. It can therefore be ensured that locking always occurs at the highest available pressure, and a higher safety standard is therefore achieved.

The invention is not limited to the embodiment example just described. Several additional control circuits can also be used instead of the two control circuits used here.

### LIST OF REFERENCE NUMBERS

1 Quick coupler
2 Connection part
3 Rotary device
4 Drive housing
5 Axis of rotation
6 Rotary joint
7 Stator
8 Rotor
9 Rotary drive
10 Drive wheel
11 Pivot axis
12 Slewing drive
13 Side walls
14 Crosspiece
15 Bearing pin
16 Bearing hole
17 Hole
18 Cylinder housing
19 Piston rod
20 Rod end bearing
21 Holder
22 Support
23 First mount
24 Second mount
25 Support surface
26 Locking element
27 Hydraulic drive
28 Cover surface
29 Bearing ring
30 Passage opening
31 Annular space
32 Peripheral wall
33 Intermediate ring
34 Base element
35 Holding flange
36 Shoulder
37 Recess
38 Upper end surface
39 Lower end of bearing ring
40 Lower end surface
41 Sealing elements
42 First channel section
43 Second channel section
44 Hydraulic control device
45 Additional load
46 Attachment
47 First control circuit
48 First directional valve
49 Second directional valve
50 Third directional valve
51 Circuit
52 First check valve
53 Second check valve
54 Third check valve
55 Fourth check valve
56 Fifth check valve
57 4/2-way valve
58 First control line
59 Second control line
60 Pressure limitation valve
61 Additional control circuit
62 Third control line
63 Fourth control line
64 Shuttle valve arrangement
65 First shuttle valve
66 Second shuttle valve

1. A quick-change system for changing attachments on a construction machine with a quick coupler, which is arranged pivotable about a pivot axis orthogonal to an axis of rotation by means of a hydraulic slewing drive and rotatable on a connection part by means of a hydraulic rotary drive about the axis of rotation, and which contains mounts and at least one locking element actuatable by means of a hydraulic drive to hold an attachment coupled to quick coupler, wherein a hydraulic control device, which contains a first control circuit to control the rotary drive and the slewing drive, at least one additional control circuit to supply the attachment coupled to the quick coupler and a shuttle valve arrangement to expose the hydraulic drive to the higher pressures acting in the first or the at least one additional control circuit for actuation of the at least one locking element.

2. The quick-change system according to claim 1, wherein the shuttle valve arrangement includes two shuttle valves arranged between the additional control circuit and the hydraulic drive.

3. The quick-change system according to claim 2, wherein both shuttle valves are connected one behind the other.

4. The quick-change system according to claim 1, wherein the shuttle valve arrangement is connected upstream of a movement control circuit to control movement of the at least one locking element actuated by the hydraulic drive between a locking position and a release position.

5. The quick-change system according to claim 4, wherein the movement control circuit contains check valves arranged in the manner of a rectifier circuit and a directional valve.

6. The quick-change system according to claim 4, wherein the first control circuit and the at least one additional control circuit are connected to the hydraulic drive via the movement control circuit and a rotary joint integrated in the quick coupler.

7. The quick-change system according to claim 6, wherein the rotary joint contains a stator arranged within a passage opening of a drive housing and a rotor mounted to rotate within the stator.

8. The quick-change system according to claim 1, wherein by means of the first control circuit, the slewing drive is controllable via a first directional valve and the rotary drive is controllable via a second directional valve.

9. The quick-change system according to claim 1, wherein by means of the first control circuit, at least one additional load is controllable via a directional valve.
